(19) United States
(12) Patent Application Publication
(10) Pub. No.: US 2026/0244083 A1
(43) Pub. Date: Aug. 20, 2026

(54) ANGLE ADJUSTMENT MECHANISM FOR DOME CAMERA

(71) Applicant: Shenzhen Reolink Technology Co., Ltd, Shenzhen (CN)

(72) Inventor: Zhongyang Cheng, Shenzhen (CN)

(21) Appl. No.: 19/641,938

(22) Filed: Apr. 8, 2026

(30) Foreign Application Priority Data
Apr. 11, 2025 (CN) 202520689176.6

(51) Int. Cl. G03B 17/56

(52) U.S. Cl. CPC G03B 17/561

(57) ABSTRACT

The present application discloses an angle adjustment mechanism for a dome camera. The angle adjustment mechanism includes a first fastener formed on one of a first spherical housing and a second spherical housing, and is spaced apart from the other spherical housing so as to allow horizontal rotation of the first spherical housing relative to the second spherical housing. The angle adjustment mechanism also includes a second fastener formed on one of a rotating bracket and a holder, and is spaced apart from the other of the rotating bracket and the holder so as to allow horizontal rotation of the rotating bracket relative to the holder. The spherical housing and the rotating bracket are connected via a connecting member which is spaced apart from the spherical housing so as to allow the vertical rotation of the spherical housing relative to the rotating bracket.

### TECHNICAL FIELD

The present application relates to the technical field of security monitoring, and in particular, to an angle adjustment mechanism for a dome camera.

### BACKGROUND

The dome type camera is a type of surveillance camera. With the expanding application fields of the surveillance camera, the dome type camera has been widely used in indoor monitoring and other occasions due to the ease of installation and adjustment, monitoring concealment and other advantages. At present, there is an urgent need to provide dome cameras with a wider shooting range.

### SUMMARY

The embodiments of the present application provide an angle adjustment mechanism for a dome camera to solve at least one of the above-mentioned technical problems.

An embodiment of the present application provides an angle adjustment mechanism for a dome camera, the dome camera comprises a spherical housing, a rotating bracket and a holder; the spherical housing comprises a first spherical housing and a second spherical housing; and the angle adjustment mechanism comprises a first fastener formed on one of the first spherical housing and the second spherical housing and is spaced apart from the other spherical housing so as to allow horizontal rotation of the first spherical housing relative to the second spherical housing; the angle adjustment mechanism also comprises a second fastener formed on one of the rotating bracket and the holder, and is spaced apart from the other of the rotating bracket and the holder so as to allow horizontal rotation of the rotating bracket relative to the holder; and the angle adjustment mechanism further comprises a connecting member, wherein the spherical housing and the rotating bracket are connected via the connecting member, and the connecting member is spaced apart from the spherical housing so as to allow the vertical rotation of the spherical housing relative to the rotating bracket.

Preferably, the angle adjustment mechanism further comprises a first limiting protrusion formed on one of the first and second spherical housings, and a first limiting rib formed on the other of the first and second spherical housings; and the first limiting protrusion cooperates with the first limiting rib to limit the horizontal rotation of the first spherical housing relative to the second spherical housing within a range of 0° to 90°.

Preferably, the angle adjustment mechanism further comprises a limiting groove formed on one of the spherical housing and the rotating bracket, and a second limiting rib formed on the other one of the spherical housing and the rotating bracket; and the second limiting rib is configured for sliding in the limiting groove, so as to limit the vertical rotation of the spherical housing relative to the rotating bracket within a range of 0° to 110°.

Preferably, the angle adjustment mechanism further comprises a second limiting protrusion and a third limiting rib; the second limiting protrusion is formed on one of the rotating bracket and the holder; the third limiting rib is formed on the other of the rotating bracket and the holder; and the second limiting protrusion cooperates with the third limiting rib, so as to limit the horizontal rotation of the rotating bracket relative to the holder within the range of 0° to 350°.

Preferably, the dome camera comprises a camera fixedly disposed on the first spherical housing, and a bottom case; the spherical housing is mounted to the rotating bracket; the rotating bracket is mounted to the holder; and the holder is fixedly disposed on the bottom case.

Preferably, the camera comprises two imaging assemblies, and each of the imaging assemblies comprises a lens, a lens ring, a light source assembly and a lens bracket; the first spherical housing comprises a housing body and a housing decoration; the housing decoration is fixedly disposed on the housing body; the lens and the light source assembly are fixedly disposed on the lens bracket; the lens bracket is fixedly disposed on the housing body; and the lens ring is fixedly disposed on the housing decoration and is aligned with the lens.

Preferably, a field of view range of the lens ranges is 100° to 120°, and an angle between a central axis of the lens and a central axis of the spherical housing is within a range of 39° to 43°.

The angle adjustment mechanism for the dome camera of the embodiment of the present application comprises a first fastener formed on one of the first spherical housing and the second spherical housing and is spaced apart from the other spherical housing so as to allow horizontal rotation of the first spherical housing relative to the second spherical housing; the angle adjustment mechanism also comprises a second fastener formed on one of the rotating bracket and the holder, and is spaced apart from the other of the rotating bracket and the holder so as to allow horizontal rotation of the rotating bracket relative to the holder; and the angle adjustment mechanism further comprises a connecting member, wherein the spherical housing and the rotating bracket are connected via the connecting member, and the connecting member is spaced apart from the spherical housing so as to allow the vertical rotation of the spherical housing relative to the rotating bracket. The angle adjustment mechanism enables the camera to be rotated in the horizontal direction and/or in the vertical direction, thereby enabling the dome camera to have a wider shooting range.

Additional aspects and advantages of the present application will be set forth in part in the description which follows and, in part, will be obvious from the description, or may be learned by practice of the present application.

### BRIEF DESCRIPTION OF THE DRAWINGS

In order to more clearly explain the embodiments of the present application or the technical solutions in the related art, a brief introduction will be made to the drawings which are required to be used in the description of the embodiments or the related art. It will be apparent to those skilled in the art that the drawings in the following description are only some embodiments of the disclosure, and that other drawings may be obtained from the structures shown in the drawings without any creative works. In the drawings:

FIG. 1 is a structurally schematic view of a dome camera according to certain embodiments of the present application;

FIG. 2 is a structurally schematic exploded view of a dome camera according to certain embodiments of the present application;

FIG. 3 is a structurally schematic exploded view of a camera and a spherical housing in a dome camera according to certain embodiments of the present application;

FIG. 4 is a schematic view showing a structure in which the spherical housing is mounted to a rotating bracket and the rotating bracket is mounted to a holder in the dome camera according to some embodiments of the present application;

FIG. 5 is a schematic view showing a structure in which a first spherical housing and a second spherical housing are not connected in the dome camera according to some embodiments of the present application;

FIG. 6 is a structurally schematic view of the spherical housing in the dome camera according to some embodiments of the present invention;

FIG. 7 is a schematic view illustrating a structure in which the rotating bracket and the holder are not connected in the dome camera according to some embodiments of the present application;

FIG. 8 is a schematic view showing a structure in which the holder and a main board are fixedly provided on a bottom case via a holder in the dome camera according to some embodiments of the present application; and

FIG. 9 is a schematic view of the field of view of the dome camera according to certain embodiments of the present application.

Description of Reference Numerals:
dome camera 100,
camera 10,
imaging assembly 11,
lens 111,
lens ring 112,
light source assembly 113,
lamp panel 1131,
lens unit 1132,
lens bracket 114,
light guide post 115,
spherical housing 20,
first spherical housing 21,
housing body 211,
housing decoration 212,
second spherical housing 22,
rotating bracket 30,
holder 40,
bottom case 50,
angle adjustment mechanism 60,
first fastener 61,
first limiting protrusion 62,
first limiting rib 63,
connecting member 64,
limiting groove 65,
second limiting rib 66,
second fastener 67,
second limiting protrusion 68,
third limiting rib 69,
sphere head cover shell 70,
damping member 80,
main board 90, and
fixing member 91.

### DETAILED DESCRIPTION

Reference will now be made in detail to the embodiments of the present application, examples of which are illustrated in the accompanying drawings, wherein like or similar reference numerals refer to the same or similar elements throughout or elements having the same or similar function. The embodiments described below with reference to the figures are exemplary only and are not to be construed as limiting the present application.

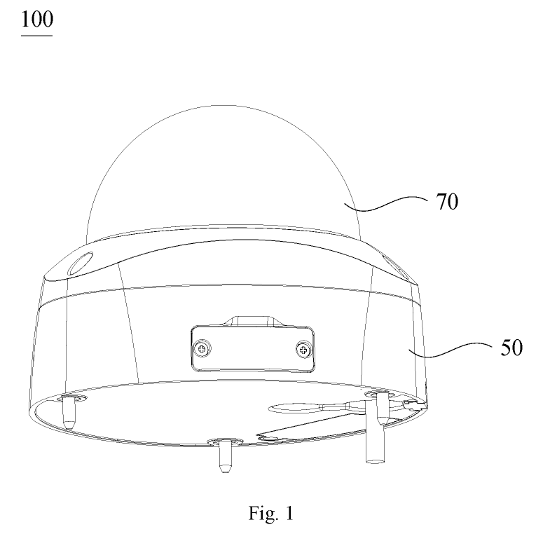

Referring to FIGS. 1 to 4, the present embodiment provides an angle adjustment mechanism 60 for a dome camera 100. The dome camera 100 includes a camera 10, a spherical housing 20, a rotating bracket 30, a holder 40, a bottom case 50, and an angle adjustment mechanism 60. The spherical housing 20 comprises a first spherical housing 21 and a second spherical housing 22, and the camera 10 is fixedly disposed in the first spherical housing 21. The spherical housing 20 is mounted to the rotating bracket 30. The rotating bracket 30 is mounted to the holder 40. The holder 40 is fixedly disposed on the bottom case 50. The angle adjustment mechanism 60 is used to perform adjustment such that the first spherical housing 21 is rotated horizontally relative to the second spherical housing 22 and the rotating bracket 30 is rotated horizontally relative to the holder 40 and/or the spherical housing 20 is rotated vertically relative to the rotating bracket 30.

In the angle adjustment mechanism 60 of the dome camera 100 according to the embodiment of the present application, the camera 10 is fixedly disposed in the first spherical housing 21, and the angle adjustment mechanism 60 is used to perform adjustment such that the first spherical housing 21 is horizontally rotated relative to the second spherical housing 22 and the rotating bracket 30 is horizontally rotated relative to the holder 40 and/or the spherical housing 20 is vertically rotated relative to the rotating bracket 30. In this manner, the camera 10 may be rotated in the horizontal direction and/or in the vertical direction, so that the dome camera 100 has a wider shooting range.

Here, the spherical housing 20 includes a first spherical housing 21 and a second spherical housing 22. The first spherical housing 21 has an overall hemispherical shape, and the second spherical housing 22 has an overall cylindrical shape. The first spherical housing 21 is assembled with the second spherical housing 22 to form the completed spherical housing 20. The camera 10 is fixedly disposed in the first spherical housing 21, and for example, may be specifically fixed to the first spherical housing 21 by a screw or a thread. When the first spherical housing 21 rotates horizontally relative to the second spherical housing 22, the camera 10 may be caused to rotate horizontally relative to the second spherical housing 22.

The spherical housing 20 is mounted on a rotating bracket 30, the rotating bracket 30 is mounted on the holder 40, and the holder 40 is fixedly disposed on the bottom case 50. For example, the holder 40 may be fixedly disposed on the bottom case 50 by means of screws. When the rotating bracket 30 rotates horizontally relative to the holder 40, the spherical housing 20 may be driven to rotate horizontally, and thus the camera 10 located on the first spherical housing 21 may be driven to rotate horizontally relative to the holder 40.

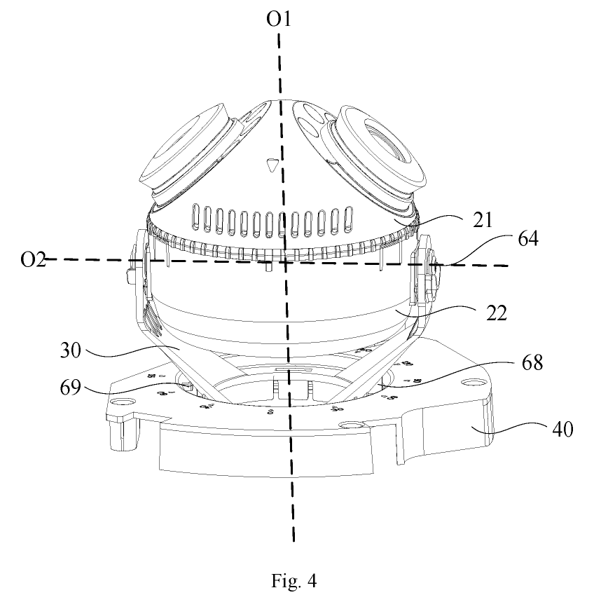

The horizontal rotation of the first spherical housing 21 relative to the second spherical housing 22 and the horizontal rotation of the rotating bracket 30 relative to the holder 40 allows the camera 10 to be rotated horizontally in a large angular range, even 360° relative to the bottom case 50 in the horizontal direction. The rotating shaft for horizontal rotation may be a central shaft of the first spherical housing 21, as indicated by a broken line O1 in FIG. 4.

When the spherical housing 20 rotates vertically relative to the rotating bracket 30, the camera 10 located on the first spherical housing 21 may be driven to rotate vertically relative to the rotating bracket 30 (namely, pitching movement). As such, the camera 10 may be rotated by a certain angle relative to the bottom case 50 in the vertical direction. The vertical rotation axis, which is perpendicular to the horizontal rotation axis, may be in the radial direction of the second spherical housing 22, as indicated by the dashed line 02 in FIG. 4.

By arranging the angle adjustment mechanism 60 in the dome camera 100, the first spherical housing 21 may rotate horizontally relative to the second spherical housing 22 and the rotating bracket 30 may rotate horizontally relative to the holder 40; or, the spherical housing 20 may rotate vertically relative to the rotating bracket 30; alternatively, the first spherical housing 21 may rotate horizontally relative to the second spherical housing 22 and the rotating bracket 30 may rotate horizontally relative to the holder 40 while the spherical housing 20 may rotate vertically relative to the rotating bracket 30. In this manner, the camera 10 may be rotated in the horizontal direction and/or in the vertical direction, so that the dome camera 100 may have a wider shooting range.

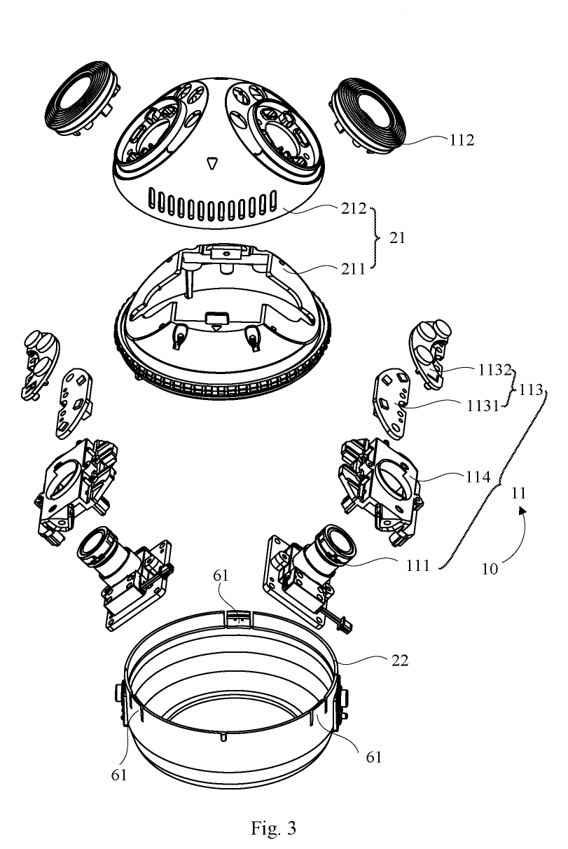

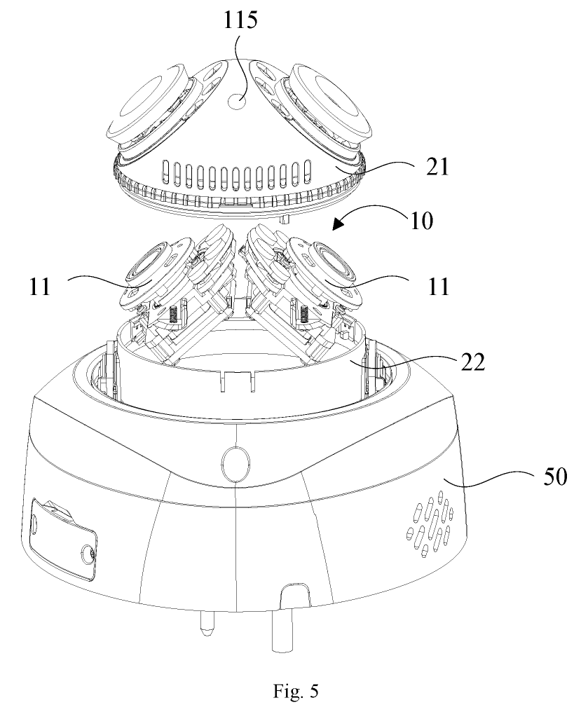

Referring to FIGS. 3 and 5, in some embodiments, the dome camera 100 is a binocular dome camera, and the camera 10 includes two imaging assemblies 11, each imaging assembly 11 including a lens 111, a lens ring 112, a light source assembly 113, and a lens bracket 114. The first spherical housing 21 includes a housing body 211 and a housing decoration 212. The housing decoration 212 is fixedly provided to the housing body 211. The lens 111 and the light source assembly 113 are fixedly provided on the lens bracket 114 which is fixedly disposed on the housing body 211. The lens ring 112 is fixedly provided on the housing decoration 212 and aligned with the lens 111.

Specifically, the dome camera 100 is a binocular dome camera, and the camera 10 includes two imaging assemblies 11, which are symmetrically disposed about a central axis O1 of the first spherical housing 21. Each imaging assembly 11 includes a lens 111, a lens ring 112, a light source assembly 113, and a lens bracket 114. In each imaging assembly 11, the number of the lens 111, the lens ring 112, the light source assembly 113, and the lens bracket 114 is one. The first spherical housing 21 includes a housing body 211 and a housing decoration 212. The housing decoration 212 is provided on the housing body 211 and is adapted to the shape of the housing body 211.

The lens 111 and the light source assembly 113 may be fixedly provided to the lens bracket 114 by screws, respectively, and the lens bracket 114 is further fixedly provided to the housing body 211 by screws. In this manner, the lens 111 and the light source assembly 113 may be fixedly provided in the housing body 211 along with the lens bracket 114.

The lens ring 112 may be fixedly provided to the housing decoration 212 by screws and aligned with the lens 111. That is, the optical axis of the lens ring 112 coincides with the optical axis of the lens 111. Then, the housing decoration 212 is fixed to the housing body 211 by screws, so that the lens ring 112 may be fixed to the housing body 211 along with the housing decoration 212.

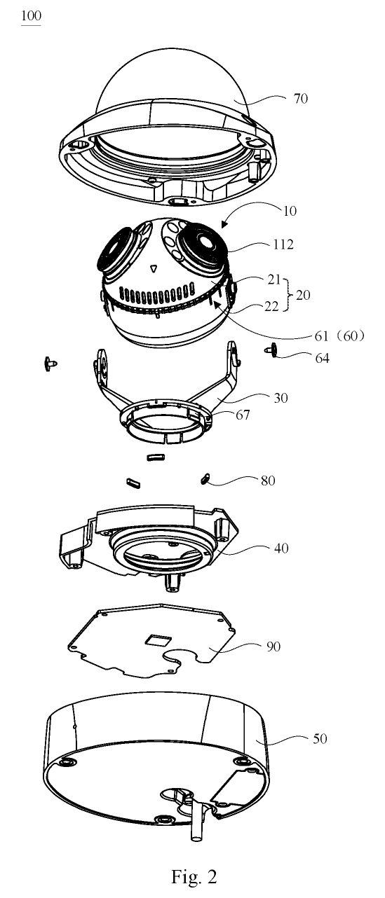

Referring to FIG. 2, the dome camera 100 may further include a sphere head cover shell 70 having a good sealing performance for keeping the camera 10 clear and preventing the camera 10 from being exposed to the outside and being damaged by the external environment. In some cases, the sphere head cover shell 70 refracts light that enters the lens 111, resulting in poor image quality when imaged, e. g., a bright spot on the image. The lens ring 112 is arranged to block the light refracted by the sphere head cover shell 70, so as to ensure the imaging quality of the lens 111.

Referring to FIG. 3, the light source assembly 113 may include a lamp panel 1131 and a lens unit 1132. The lamp panel 1131 may be a white light and an infrared light bi-color lamp panel, and is switched to emit white light or infrared light. The lens unit 1132 is covered on the lamp panel 1131. The lens unit 1132 comprises a white light lens and an infrared light lens. The lens unit 1132 may function to uniformly emit light.

The imaging assembly 11 may further comprise a light guide post 115 for detecting ambient light, so that the lamp panel 1131 may be controlled to switch different emitted lights in different environments according to the detection result, so as to take a clear picture. It will be appreciated that the infrared light is suitable for photographing in a normal lighting environment, and the infrared light is suitable for photographing in a darker environment. When it is detected that the ambient light is normal, for example, when the dome camera 100 is in a daytime environment, the lamp panel 1131 is controlled to emit the white light to take a picture. When it is detected that the ambient light is dark, for example, when the dome camera 100 is in a night environment, the lamp panel 1131 is controlled to emit infrared light to take a picture.

Referring to FIG. 3, in some embodiments, the angle adjustment mechanism 60 includes a first fastener 61. The first fastener 61 is formed on one of the first and second spherical housings 21 and 22 and having a gap with the other of the first and second spherical housings 21 and 22 for horizontal rotation of the first spherical housing 21 relative to the second spherical housing 22.

Specifically, the first spherical housing 21 and the second spherical housing 22 may be connected by the first fastener 61. The first fastener 61 may be formed on any one of the first spherical housing 21 and the second spherical housing 22. For example, the first fastener 61 may be formed on the first spherical housing 21, so that when the first spherical housing 21 is connected to the second spherical housing 22, there is a gap between the first fastener 61 and the second spherical housing 22 in the radial direction. The first fastener 61 may also be formed on the second spherical housing 22 (as shown in FIG. 3), so that when the first spherical housing 21 is connected to the second spherical housing 22, there is a gap between the first fastener 61 and the first spherical housing 21 in the radial direction. The number of the first fastener 61 is not limited. For example, the number of the first fastener 61 may be 1, 2, 3 (as shown in FIG. 3) or more.

Taking FIG. 3 as an example, the gap between the first fastener 61 and the second spherical housing 22 causes that the first fastener 61 may rotate horizontally relative to the second spherical housing 22, and thus the first spherical housing 21 may rotate horizontally relative to the second spherical housing 22. After the first spherical housing 21 is horizontally rotated by a certain angle relative to the second spherical housing 22, in a natural state, a friction force exists between the first spherical housing 21 and the second spherical housing 22, so that it may be ensured that the connection between the first spherical housing 21 and the second spherical housing 22 cannot be loosened at will without expected intervention, resulting in a change in the angle of the camera 10, and the expected intervention may occur in the case of manual rotation by a person or electrical control.

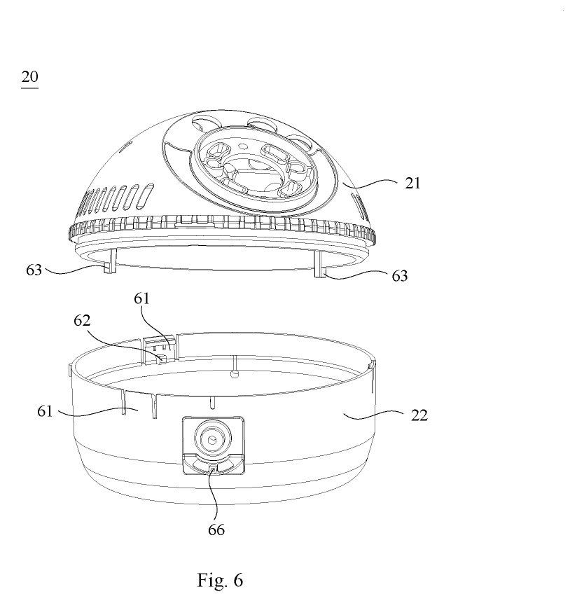

Referring to FIG. 6, in some embodiments, the angle adjustment mechanism 60 further includes a first limiting protrusion 62 and a first limiting rib 63. The first limiting protrusion 62 is formed on one of the first and second spherical housings 21 and 22, and the first limiting rib 63 is formed on the other of the first and second spherical housings 21 and 22. The first limiting protrusion 62 cooperates with the first limiting rib 63 to limit the horizontal rotation of the first spherical housing 21 relative to the second spherical housing 22 by 0°-90°.

Herein, the first limiting protrusion 62 is formed on any one of the first and second spherical housings 21 and 22, and the first limiting rib 63 is formed on the other one of the first and second spherical housings 21 and 22. For example, when the first limiting protrusion 62 is formed on the first spherical housing 21, the first limiting rib 63 is formed on the second spherical housing 22. When the first limiting protrusion 62 is formed on the second spherical housing 22, the first limiting rib 63 is formed on the first spherical housing 21. The number of the first limiting ribs 63 may be two, and two of the first limiting ribs 63 are spaced apart by 90° in the circumferential direction of the first spherical housing 21 or the second spherical housing 22.

As shown in FIG. 6, taking the example that the first limiting protrusion 62 is formed on the second spherical housing 22 and the first limiting rib 63 is formed on the first spherical housing 21, when the first spherical housing 21 is connected to the second spherical housing 22, the first limiting protrusion 62 is located between two of the first limiting ribs 63, and the height of the first limiting protrusion 62 and the first limiting rib 63 at least partially overlap along the height direction of the spherical housing 20. The first limiting protrusion 62 may be formed on the first fastener 61, or may be formed on other positions on the second spherical housing 22 at the same height. As the first spherical housing 21 is rotated horizontally relative to the second spherical housing 22, the first limiting protrusion 62 rotates horizontally with the second spherical housing 22 between two first limiting ribs 63. When the first limiting protrusion 62 is rotated to a position where the first limiting rib 63 is located, since the heights of the first limiting protrusion 62 and the first limiting rib 63 at least partially overlap, the first limiting rib 63 abuts against the first limiting protrusion 62 to limit the rotation of the first limiting protrusion 62, thereby limiting the horizontal rotation of the first spherical housing 21 relative to the second spherical housing 22. The first spherical housing 21 may rotate horizontally relative to the second spherical housing 22 at an angle ranging from 0° to 90°.

In practice, the dome camera 100 may be fixed indoors or outdoors by means of bolts or the like, and specifically may be fixed to a roof (i. e., mounted on a ceiling) or fixed to a wall (i. e., mounted on a wall). During the lifting or mounting, the dome camera 100 is located at different spatial positions, and the direction in which the camera 10 captures a picture is different. Therefore, when the mounting manner is changed, the camera 10 needs to be rotated in order to ensure that the captured picture is kept in the forward direction. It has been found that when switching from the lifting to the wall mounting, the first spherical housing 21 is rotated 90° horizontally relative to the second spherical housing 22, so that the shooting picture may be kept in a positive direction. Therefore, in the embodiment of the present application, the angle for restricting the horizontal rotation of the first spherical housing 21 relative to the second spherical housing 22 ranges from 0° to 90°. Of course, in other embodiments, a greater range of angles for the horizontal rotation of the first spherical housing 21 relative to the second spherical housing 22 may be provided, for example, 0°-100°, 0°-110°, or 0°-120°, etc.

Referring to FIGS. 2, 4, and 7, in some embodiments, the angle adjustment mechanism 60 includes a connecting member 64. The spherical housing 20 is connected to the rotating bracket 30 by the connecting member 64. There is a gap between the connecting member 64 and the spherical housing 20 to allow the spherical housing 20 to rotate vertically relative to the rotating bracket 30.

Specifically, the connecting member 64 may be a screw, or may be another member having a connecting function. The connecting member 64 is used to connect the spherical housing 20 with the rotating bracket 30. There is a gap between the connecting member 64 and the spherical housing 20, and the gap may provide a space so that the spherical housing 20 may rotate vertically relative to the rotating bracket 30.

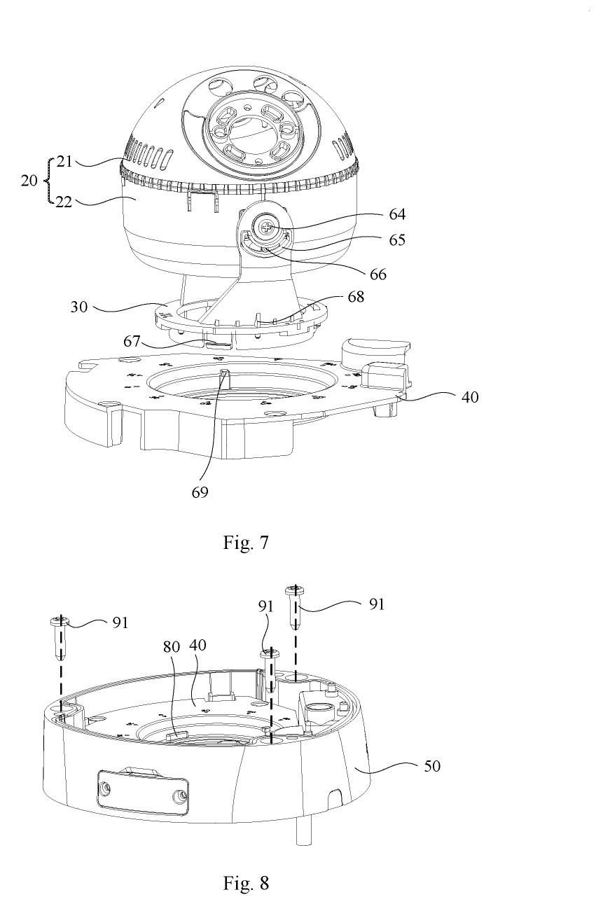

Referring to FIG. 7, in some embodiments, the angle adjustment mechanism 60 further includes a limiting groove 65 and a second limiting rib 66. The limiting groove 65 is formed on one of the spherical housing 20 and the rotating bracket 30, and a second limiting rib 66 is formed on the other one of the spherical housing 20 and the rotating bracket 30. The second limiting rib 66 is adapted to slide within the limit slot 65 to limit the vertical rotation of the spherical housing 20 from relative to the rotating bracket 30 by 0°-110°.

Specifically, the limiting groove 65 may be formed on the spherical housing 20, and at this time, the second limiting rib 66 is formed on the rotating bracket 30. The limiting groove 65 may be formed on the rotating bracket 30, and at this time, the second limit skeleton is formed on the spherical housing 20. The number of the limiting grooves 65 and the second limiting ribs 66 may both be two. The two limiting grooves 65 are respectively located at two opposite ends of one of the spherical housing 20 and the rotating bracket 30, and the two second limiting ribs 66 are located at two opposite ends of the other of the spherical housing 20 and the rotating bracket 30.

The limiting groove 65 may be provided in a circular arc shape, and the second limiting rib 66 may slide along the circular arc in the limiting groove 65, so that the sphere head may rotate vertically relative to the rotating bracket 30. The rotary shaft is an imaginary line O2 in FIG. 4, and the imaginary line O2 may be a connecting line of the centers of the circular arcs where the two limiting grooves 65 are respectively located. The angular range in which the spherical housing 20 is vertically rotated relative to the rotating bracket 30 may be limited by limiting the length of the limiting groove 65. The angular range may be set accordingly according to practical requirements, so that the dome camera 100 has a wider shooting range. For example, it has been found that when the angle of the spherical housing 20 relative to the rotating bracket 30 is in the range of 0°-110°, which may meet the shooting requirements in practical applications. Then, by limiting the length of the limiting groove 65, it is possible to limit the range of the angle at which the spherical housing 20 is vertically rotated relative to the rotating bracket 30 to be 0°-110°.

Referring to FIG. 7, in some embodiments, the angle adjustment mechanism 60 includes a second fastener 67 formed on one of the rotating bracket 30 and the holder 40 and having a gap with the other of the rotating bracket 30 and the holder 40 for horizontal rotation of the rotating bracket 30 relative to the holder 40.

In particular, the rotating bracket 30 and the holder 40 may be connected by a second fastener 67. The second fastener 67 may be formed on any one of the rotating bracket 30 and the holder 40. For example, the second fastener 67 may be formed on the rotating bracket 30 (as shown in FIG. 7) and have a gap from the holder 40 in the radial direction. The second fastener 67 may also be formed on the holder 40, the second fastener 67 being radially spaced from the rotating bracket 30. The number of the second fastener 67 is not limited. For example, the number of the second fastener 67 may be one, two, three (as shown in FIG. 2) or more.

By way of example in FIG. 7, the gap between the second fastener 67 and the holder 40 causes that the second fastener 67 may rotate horizontally relative to the holder 40 and thus the rotating bracket 30 may rotate horizontally relative to the holder 40. After the rotating bracket 30 is horizontally rotated by a certain angle relative to the holder 40, the friction force exists between the rotating bracket 30 and the holder 40 in a natural state, so that it may be ensured that the connection between the rotating bracket 30 and the holder 40 cannot be loosened at will without expected intervention, which may occur in the case of manual rotation or electric control, resulting in a change in the angle.

Referring to FIGS. 4 and 7, in certain embodiments, the angle adjustment mechanism 60 further includes a second limiting protrusion 68 and a third limiting rib 69. The second limiting protrusion 68 is formed on one of the rotating bracket 30 and the holder 40, and the third limiting rib 69 is formed on the other one of the rotating bracket 30 and the holder 40. The second limiting protrusion 68 cooperates with the third limiting rib 69 to limit the horizontal rotation of the rotating bracket 30 relative to the holder 40 by 0°-350°.

Among them, the second limiting protrusion 68 is formed on any one of the rotating bracket 30 and the holder 40, and a third limiting rib 69 is formed on the other one of the rotating bracket 30 and the holder 40. For example, when the second limiting protrusion 68 is formed on the rotating bracket 30, the third limiting rib 69 is formed on the holder 40. When the second limiting protrusion 68 is formed on the holder 40, the third limiting rib 69 is formed on the rotating bracket 30. The number of the third limiting ribs 69 may be one, and may be located at any position in the circumferential direction of the rotating bracket 30 or the holder 40.

As shown in FIG. 7, taking the example that the second limiting protrusion 68 is formed on the rotating bracket 30 and the third limiting rib 69 is formed on the holder 40, when the rotating bracket 30 is connected to the holder 40 (as shown in FIG. 4), the height of the second limiting protrusion 68 and the third limiting rib 69 at least partially overlap in the height direction of the spherical housing 20. When the rotating bracket 30 rotates horizontally relative to the holder 40, the second limiting protrusion 68 rotates horizontally with the holder 40. When the second limiting protrusion 68 is rotated to a position where the third limiting rib 69 is located, since the heights of the second limiting protrusion 68 and the third limiting rib 69 at least partially overlap, the third limiting rib 69 may abut against the second limiting protrusion 68 to limit the rotation of the second limiting protrusion 68, thereby limiting the horizontal rotation of the rotating bracket 30 relative to the holder 40. The rotating bracket 30 may rotate horizontally relative to the holder 40 at an angle ranging from 0° to 350°.

It will be appreciated that the third limiting rib 69 has a width that limits horizontal rotation of the rotating bracket 30 relative to the holder 40 by no more than 360°. However, the rotating bracket 30 is horizontally rotated at an angle ranging from 0° to 350° relative to the holder 40. In combination with the above-mentioned first spherical housing 21 being horizontally rotated at an angle ranging from 0° to 90° relative to the second spherical housing 22, the first spherical housing 21 is horizontally rotated by an angle ranging from 0° to 360° relative to the holder 40. In this manner, the camera 10 may be rotated in the horizontal direction by 0°-360°, so that the dome camera 100 may have a wide shooting range.

Referring to FIG. 2, in some embodiments, the dome camera 100 further comprises a damping member 80 disposed between the rotating bracket 30 and the holder 40.

Specifically, the damping member 80 may be made of a silicone material. The damping member 80 is provided between the rotating bracket 30 and the holder 40. When the rotating bracket 30 rotates horizontally relative to the holder 40, the damping member 80 may increase the damping and adjust the rotating feel of the rotating bracket 30. The number of damping members 80 is not limited. For example, the number of damping members 80 may be one, two, three (as shown in FIG. 2), or more.

Referring to FIG. 8, in some embodiments, the dome camera 100 further comprises a main board 90 and a holder 91, and the holder 40 and the main board 90 are fixedly provided on the bottom case 50 via the fixing member 91.

In particular, a plurality of functional components may be integrated on the main board 90 to control the operation of the dome camera 100. The holder 40 and the main board 90 may be fixedly provided on the bottom case 50 by means of the holder 91, which may be a screw or other member capable of fixedly connecting. The number of the holders 91 is not limited. For example, the number of the holders 91 may be 1, 2, 3 or more.

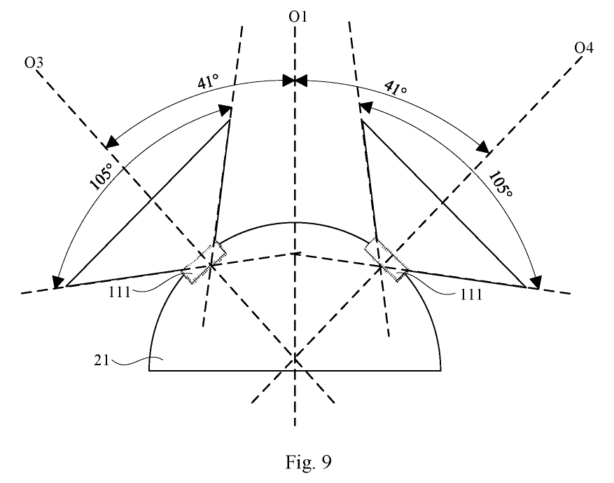

Referring to FIGS. 3 and 9, in some embodiments, the dome camera 100 is a binocular dome camera. The camera 10 comprises two imaging assemblies 11. Each imaging assembly 11 comprises a lens 111. The field angle of the lens 111 is in the range of 100°-120°, and the angle between the central axis of the lens 111 and the central axis of the spherical housing 20 is in the range of 39°-43°.

Specifically, the field angle of each lens 111 ranges from 100°-120° and the angle between the central axis of the lens 111 (dashed lines O3 and O4 in FIG. 9) and the central axis of the spherical housing 20 (dashed line O1 in FIG. 9) ranges from 39°-43°. As in the example of FIG. 9, each lens 111 has a field of view of 105°, and the angle between the central axis of the lens 111 and the central axis of the spherical housing 20 is 41°. The pictures shot by the two lenses 111 are spliced and cut by the software, and an image with a field of view greater than 180° may be obtained. The camera 10 has a larger field of view than that of a monocular camera .

In the related art, when a fisheye lens is used to capture a picture, although the angle of field of view of a single lens of the fisheye lens exceeds 180°, the captured image is seriously distorted and the imaging quality is low. However, in the embodiment of the present application, two lenses 111 are used for photographing, and the image quality is ensured while the field of view is expanded.

In summary, in the angle adjustment mechanism 60 of the dome camera 100 according to the embodiment of the present application, the camera 10 is fixedly disposed in the first spherical housing 21, and the angle adjustment mechanism 60 is used to perform adjustment such that the first spherical housing 21 is horizontally rotated relative to the second spherical housing 22 and the rotating bracket 30 is horizontally rotated relative to the holder 40 and/or the spherical housing 20 is vertically rotated relative to the rotating bracket 30. In this manner, the camera 10 may be rotated in the horizontal direction and/or in the vertical direction, so that the dome camera 100 has a wider shooting range.

In the description of the present application, it should be understood that the directional or positional relationships indicated by the terms "center", "longitudinal", "transverse", "length", "width", "thickness", "upper", "lower", "front", "rear", "left", "right", "vertical", "horizontal", "top", "bottom", "inner", "outer", "clockwise", "counterclockwise", and the like are based on the directional or positional relationships shown in the drawings. It is merely for the purpose of describing the present application and simplifying the description, and is not intended to indicate or imply that a particular orientation, configuration and operation of the referenced device or element is required and should not be construed as limiting the scope of the present application. Furthermore, the terms "first" and "second" are used for descriptive purposes only and are not to be construed as indicating or implying relative importance or implicitly indicating the number of technical features indicated. Thus, a feature defined as "first" or "second" may explicitly or implicitly comprise one or more features. In the description of the present application, the meaning of "a plurality" is two or more, unless specifically limited otherwise.

In the description of the present application, it should be noted that, unless expressly specified and limited otherwise, the terms "mounted", "connected", and "coupled" are to be interpreted broadly, and may, for example, be fixedly connected, detachably connected, or integrally connected. The terms may be mechanically connected, or may be electrically connected. They may be directly connected or indirectly connected by an intermediate medium, and may be connected within two elements or in an interactive relationship between the two elements. The specific meaning of the above terms in the present application may be understood by those of ordinary skill in the art according to the particular circumstances.

In the present application, unless expressly stated or limited otherwise, reference to a first feature as being "on" or "under" a second feature may include reference to the first and second features being in direct contact, as well as reference to the first and second features not being in direct contact but being in contact by additional features between them. Further, the first feature being "above”, "over", and "on the top of" the second feature includes the first feature being directly above and obliquely above a second feature, or merely indicates that the first feature is at a higher level than the second feature. The first feature being "below", "below", and "at the bottom of" the second feature includes the first feature being directly below and diagonally below the second feature, or merely indicates that the first feature is at a lower level than the second feature.

The above disclosure provides many different implementations or examples for implementing different structures of the present application. To simplify the disclosure of the present application, components and arrangements of particular examples have been described above. They are, of course, merely examples and are not intended to limit the present application. Further, the present application may repeat reference numerals and/or reference letters in different instances, such repetition being for the purpose of simplicity and clarity and not in itself indicative of a relationship between the various embodiments and/or arrangements discussed. In addition, the present application provides examples of various specific processes and materials, but one of ordinary skill in the art may recognize the application of other processes and/or the use of other materials.

In the depiction of the present description, references to terms such as "one embodiment," "some embodiments," "an illustrative embodiment," "example," "specific example," or "some examples" mean that particular features, structures, materials, or characteristics described in connection with the embodiments or examples is included in at least one embodiment or example of the present application. In the present description, schematic depictions of the above terms do not necessarily refer to the same embodiments or examples. Furthermore, the particular features, structures, materials, or characteristics described may be combined in any suitable manner in any one or more of the embodiments or examples.

While embodiments of the present application have been shown and described, it will be appreciated by those skilled in the art that many changes, modifications, substitutions, and variations may be made to these embodiments without departing from the principles and spirit of the present application, the scope of which is defined by the claims and their equivalents.

What is claimed is:

1. An angle adjustment mechanism (60) for a dome camera (100), the dome camera comprising a spherical housing (20), a rotating bracket (30), and a holder (40), the spherical housing (20) comprising a first spherical housing (21) and a second spherical housing (22), characterized in that the angle adjustment mechanism (60) comprises:
a first fastener (61) formed on one of the first spherical housing (21) and the second spherical housing (22), and is spaced apart from the other spherical housing (21)so as to allow horizontal rotation of the first spherical housing (21) relative to the second spherical housing;
a second fastener (67) formed on one of the rotating bracket (30) and the holder (40), and is spaced apart from the other of the rotating bracket (30) and the holder (40) so as to allow horizontal rotation of the rotating bracket (30) relative to the holder (40); and
a connecting member (64), wherein the spherical housing (20) and the rotating bracket (30) are connected via the connecting member (64), and the connecting member (64) is spaced apart from the spherical housing (20) so as to allow the vertical rotation of the spherical housing (20) relative to the rotating bracket (30).

2. The angle adjustment mechanism (60) for the dome camera (100) according to claim 1, characterized in that the angle adjustment mechanism (60) further comprises a first limiting protrusion (62) formed on one of the first and second spherical housings (21, 22), and a first limiting rib (63) formed on the other of the first and second spherical housings (21, 22); the first limiting protrusion (62) cooperates with the first limiting rib (63) to limit the horizontal rotation of the first spherical housing (21) relative to the second spherical housing (22) within a range of 0° to 90°.

3. The angle adjustment mechanism (60) for the dome camera (100) according to claim 1, characterized in that the angle adjustment mechanism (60) further comprises a limiting groove (65) formed on one of the spherical housing (20) and the rotating bracket (30), and a second limiting rib (66) formed on the other one of the spherical housing (20) and the rotating bracket (30); and the second limiting rib (66) is configured for sliding in the limiting groove (65), so as to limit the vertical rotation of the spherical housing (20) relative to the rotating bracket (30) within a range of 0° to 110°.

4. The angle adjustment mechanism (60) for the dome camera (100) according to claim 1, characterized in that the angle adjustment mechanism (60) further comprises a second limiting protrusion (68) and a third limiting rib (69); the second limiting protrusion (68) is formed on one of the rotating bracket (30) and the holder (40); the third limiting rib (69) is formed on the other of the rotating bracket (30) and the holder (40); and the second limiting protrusion (68) cooperates with the third limiting rib (69), so as to limit the horizontal rotation of the rotating bracket (30) relative to the holder (40) within the range of 0° to 350°.

5. The angle adjustment mechanism (60) for the dome camera (100) according to claim 1, characterized in that the dome camera further comprises a camera (10) and a bottom case (50);
the camera (10) is fixedly disposed in the first spherical housing (21);
the spherical housing (20) is mounted to the rotating bracket (30);
the rotating bracket (30) is mounted to the holder (40); and
the holder (40) is fixedly disposed on the bottom case (50).

6. The angle adjustment mechanism (60) for the dome camera (100) according to claim 5, characterized in that the camera(10) comprises two imaging assemblies (11); each imaging assembly (11) comprises a lens (111), a lens ring (112), a light source assembly (113) and a lens bracket (114);
the first spherical housing (21) comprises a housing body (211) and a housing decoration (212); the housing decoration (212) is fixedly disposed on the housing body (211); the lens (111) and the light source assembly (113) are fixedly disposed on the lens bracket (114);the lens bracket (114) is fixedly disposed on the housing body (211); and the lens ring (112) is fixedly disposed on the housing decoration (212) and is aligned with the lens (111).

7. The angle adjustment mechanism (60) for the dome camera (100) according to claim 6, characterized in that wherein a field of view range of the lens (111) is 100° to 120°, and an angle between a central axis of the lens (111) and a central axis of the spherical housing (20) is within a range of 39° to 43°.
